(19) United States
(12) Patent Application Publication
(10) Pub. No.: US 2025/0079100 A1
(43) Pub. Date: Mar. 6, 2025

(54) CONTACTOR MOVABLE CONTACT ASSEMBLY AND CONTACTOR

(71) Applicant: Tyco Electronics (Shanghai) Co., Ltd., Shanghai (CN)

(72) Inventors: Jun (Tod) Chen, Shenzhen (CN); Shixiong (Stephen) Cao, Shenzhen (CN)

(73) Assignee: Tyco Electronics (Shanghai) Co., Ltd., Shanghai (CN)

(21) Appl. No.: 18/815,957

(22) Filed: Aug. 27, 2024

(30) Foreign Application Priority Data
Aug. 31, 2023 (CN) 202322367305.3

(51) Int. Cl. H01H 50/18

(52) U.S. Cl. CPC H01H 50/18

(57) ABSTRACT

A contactor movable contact assembly includes a driving shaft having a shoulder, a movable contact movably installed axially on the driving shaft and positioned above the shoulder, a spring component axially compressed between the shoulder of the driving shaft and the movable contact, and an insulator fixed on the driving shaft and electrically isolating the driving shaft from the movable contact. The driving shaft drives the movable contact from an opened position electrically separated from a static contact to a closed position electrically in contact with the static contact. The spring component applies a predetermined contact pressure on the movable contact to ensure reliable electrical contact between the movable contact and the static contact. A portion of the driving shaft between the shoulder and an upper end of the driving shaft is completely wrapped in the insulator to increase a creepage distance between the driving shaft and the movable contact.

### CROSS-REFERENCE TO RELATED APPLICATIONS

This application claims the benefit of the filing date under 35 U.S.C. § 119(a)-(d) of Chinese Patent Application No. 202322367305.3, filed on Aug. 31, 2023.

### FIELD OF THE INVENTION

The present invention relates to a contactor movable contact assembly and a contactor comprising the contactor movable contact assembly.

### BACKGROUND OF THE INVENTION

A contactor movable contact assembly usually includes a movable contact, a driving shaft, a spring component, an upper insulation ring, and a lower insulation ring. The movable contact is axially movably installed on the driving shaft. The driving shaft is used to drive the movable contact from an opened position separated from the static contact to a closed position in electrical contact with the static contact. The spring component is floatable and supports the movable contact on the driving shaft, used to apply a predetermined contact pressure to the movable contact. The upper insulation ring and the lower insulation ring are assembled together and set between the movable contact and the driving shaft to electrically separate the movable contact from the driving shaft. The driving shaft passes through a center hole of the lower insulation ring, and the lower insulation ring is in contact with the shoulder of the driving shaft. The spring component is sleeved on the lower insulation ring. The upper insulation ring is inserted into a through hole in the middle of the movable contact, and the driving shaft passes through the center hole of the upper insulation ring.

There is relative sliding and friction between the driving shaft and the upper and lower insulation rings during the closing and opening operation of the contactor. There is relative sliding and friction between the outer cylindrical surface of the upper insulation ring and the inner cylindrical surface of the lower insulation ring. There is relative sliding and friction between the spring component and the lower insulation ring. There is relative sliding and friction between the limiting ring and the upper insulation ring, and relative sliding and friction between the upper insulation ring and the movable contact. There are a total of 6 friction pairs in the contactor movable contact assembly, which can generate a large amount of dust and easily lead to poor conductivity between the movable contact and the static contact.

In addition, the creepage distance along the insulation ring surface between the movable contact (a high-voltage system component) and the driving shaft (a low-voltage system component) is relatively short, which cannot meet the requirements of creepage distance and electrical isolation of high-voltage and low-voltage systems.

### SUMMARY OF THE INVENTION

A contactor movable contact assembly includes a driving shaft having a shoulder, a movable contact movably installed axially on the driving shaft and positioned above the shoulder, a spring component axially compressed between the shoulder of the driving shaft and the movable contact, and an insulator fixed on the driving shaft and electrically isolating the driving shaft from the movable contact. The driving shaft drives the movable contact from an opened position electrically separated from a static contact to a closed position electrically in contact with the static contact. The spring component applies a predetermined contact pressure on the movable contact to ensure reliable electrical contact between the movable contact and the static contact. A portion of the driving shaft between the shoulder and an upper end of the driving shaft is completely wrapped in the insulator to increase a creepage distance between the driving shaft and the movable contact.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a contactor movable contact assembly according to a first embodiment;

FIG. 2 shows an axial sectional view of the contactor movable contact assembly according to the first embodiment, wherein the movable contact is in an opened position electrically separated from the static contact;

FIG. 3 shows an axial sectional view of the contactor movable contact assembly according to the first embodiment, wherein the movable contact is in a closed position in electrical contact with the static contact;

FIG. 4 shows an axial sectional view of the contactor movable contact assembly according to a second embodiment, wherein the movable contact is in an opened position electrically separated from the static contact;

FIG. 5 shows an axial sectional view of the contactor movable contact assembly according to the second embodiment, wherein the movable contact is in a closed position in electrical contact with the static contact;

FIG. 6 shows an axial sectional view of the contactor movable contact assembly according to a third embodiment, wherein the movable contact is in an opened position electrically separated from the static contact;

FIG. 7 shows an axial sectional view of the contactor movable contact assembly according to the third embodiment, wherein the movable contact is in a closed position in electrical contact with the static contact;

FIG. 8 shows an axial sectional view of the contactor movable contact assembly according to a fourth embodiment, wherein the movable contact is in an opened position electrically separated from the static contact;

FIG. 9 shows an axial sectional view of the contactor movable contact assembly according to a fifth embodiment, wherein the movable contact is in an opened position electrically separated from the static contact;

FIG. 10 shows an axial sectional view of the contactor movable contact assembly according to a sixth embodiment, wherein the movable contact is in an opened position electrically separated from the static contact; and

FIG. 11 shows an axial sectional view of the contactor movable contact assembly according to a seventh embodiment, where the movable contact is in an opened position electrically separated from the static contact.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

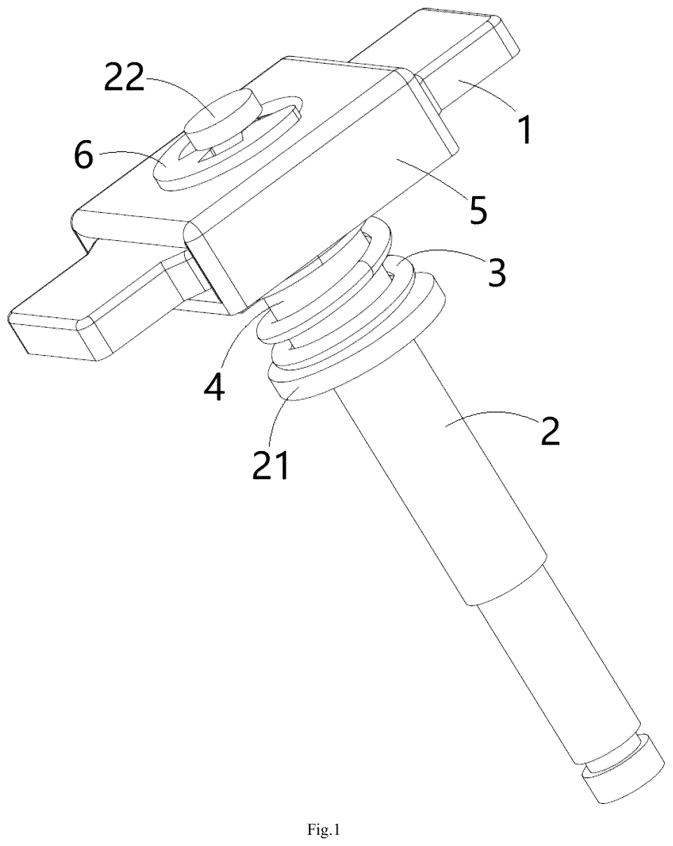

As shown in FIGS. 1 to 3, in a first exemplary embodiment of the present invention, a contactor movable contact assembly is disclosed. The contactor movable contact assembly includes a movable contact 1, a driving shaft 2, a spring component 3, and an insulator 4. The driving shaft 2 is formed with a shoulder 21. The movable contact 1 is axial movably installed on the driving shaft 2 and is located above the shoulder 21. The spring component 3 is axially compressed between the shoulder 21 of the driving shaft 2 and the movable contact 1. The insulator 4 is fixed on the driving shaft 2 to electrically isolate the driving shaft 2 from the movable contact 1.

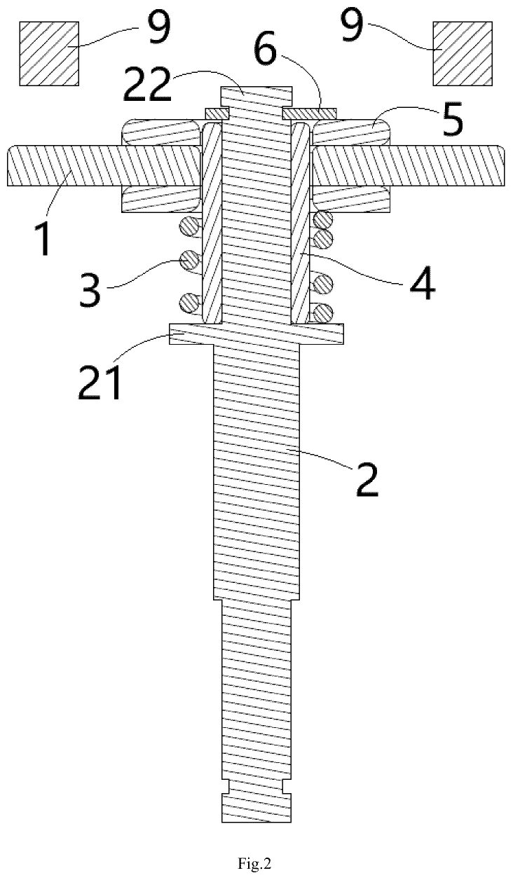

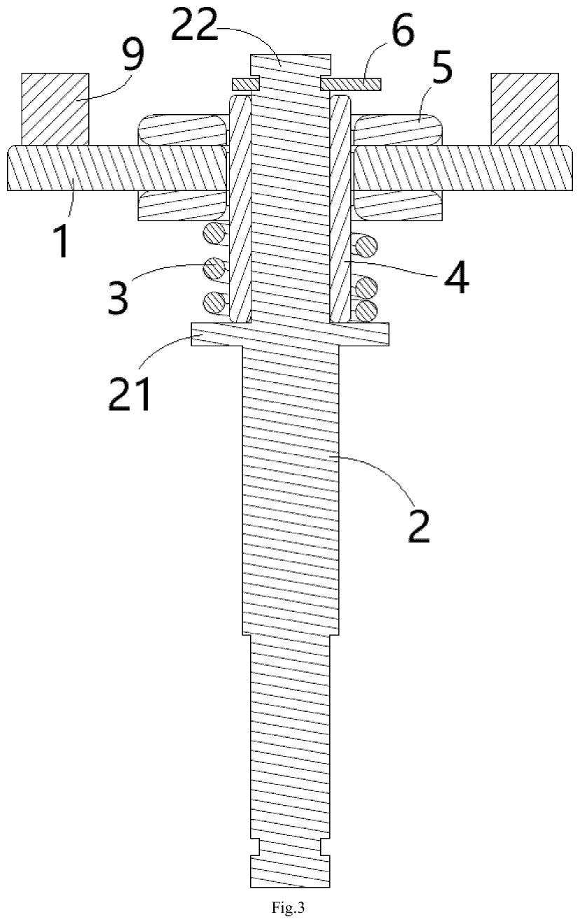

The driving shaft 2 is used to drive the movable contact 1 from an opened position electrically separated from a static contact 9, shown in FIG. 2, to a closed position electrically in contact with the static contact 9, shown in FIG. 3. When the movable contact 1 is moved to the closed position, the spring component 3 applies a predetermined contact pressure on the movable contact 1 to ensure reliable electrical contact between the movable contact 1 and the static contact 9. The part between the shoulder 21 and an upper end 22 of the driving shaft 2 is completely wrapped in the insulator 4 to increase the creepage distance between the driving shaft 2 and the movable contact 1.

As shown in FIGS. 1 to 3, in the illustrated embodiment, the contactor movable contact assembly further comprises an insulation frame 5. The insulation frame 5 is fixed to the movable contact 1 for driving an auxiliary contact and for electrically isolating the spring component 3 from the movable contact 1. A through hole is formed in the insulation frame 5 and the movable contact 1 to allow the insulator 4 to pass through.

As shown in FIGS. 1 to 3, in the illustrated embodiments, the insulator 4 is cylindrical and extends continuously from the top surface of the shoulder 21 of the driving shaft 2 to the vicinity of the upper end 22 of the driving shaft 2. The spring component 3 is installed on the insulator 4 and its upper and lower ends are respectively pressed against the bottom surface of the insulation frame 5 and the top surface of shoulder 21 of the driving shaft 2.

As shown in FIGS. 1 to 3, in the illustrated embodiment, the upper end 22 of the driving shaft 2 is exposed from the insulator 4, and a limiting ring 6 is installed on the upper end 22 of the driving shaft 2. As shown in FIG. 2, when the movable contact 1 is in the opened position, the limiting ring 6 is pressed against the top surface of the insulation frame 5 to limit the movable contact 1 at a predetermined position relative to the driving shaft 2. As shown in FIG. 3, when the movable contact 1 is in the closed position, the movable contact 1 is moved axially by a predetermined distance relative to the limiting ring 6, so that the limiting ring 6 is separated from the insulation frame 5 by the predetermined distance.

In an embodiment, the insulator 4 is formed on the driving shaft 2 through an embedded injection molding process, so that the insulator 4 and the driving shaft 2 are formed into an integral piece.

In another embodiment, a contactor is also disclosed. The contactor includes: a housing, a static contact, a coil, and the aforementioned contactor movable contact assembly. The static contact 9 is fixed to the housing. The coil is installed in the housing. The contactor movable contact assembly is movably arranged in the housing. When the coil is energized, the driving shaft 2 drives the movable contact 1 from the open position to the closed position under the electromagnetic force generated by the coil.

In another embodiment of the present invention, a contactor without an auxiliary contact is also disclosed. The contactor includes: a housing; a seat provided on the housing; a magnetic circuit assembly installed in the housing; a coil assembly installed in the magnetic circuit assembly; a static contact is fixed to the seat; and the above contactor movable contact assembly movably arranged in the housing. When the coil assembly is energized, the driving shaft 2 drives the movable contact 1 from the opened position to the closed position under the electromagnetic force generated by the coil assembly and the magnetic circuit assembly.

In another embodiment, a contactor with an auxiliary contact is also disclosed. The contactor includes: a housing; a seat provided on the housing; a magnetic circuit assembly installed in the housing; a coil assembly installed in the magnetic circuit assembly; a static contact is fixed to the seat; an auxiliary contact is fixed to the base; and the above contactor movable contact assembly movably arranged in the housing. When the coil assembly is energized, the driving shaft 2 drives the movable contact 1 from the opened position to the closed position under the electromagnetic force generated by the coil assembly and the magnetic circuit assembly, while driving the auxiliary contact to change its contact state. For example, changing the auxiliary contact from an opened state to a closed state or from a closed state to an opened state.

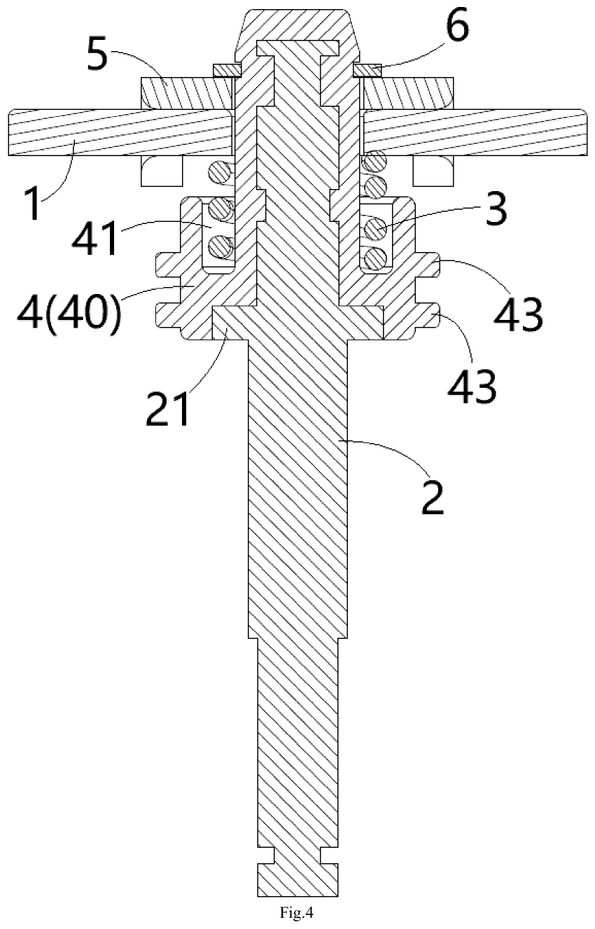

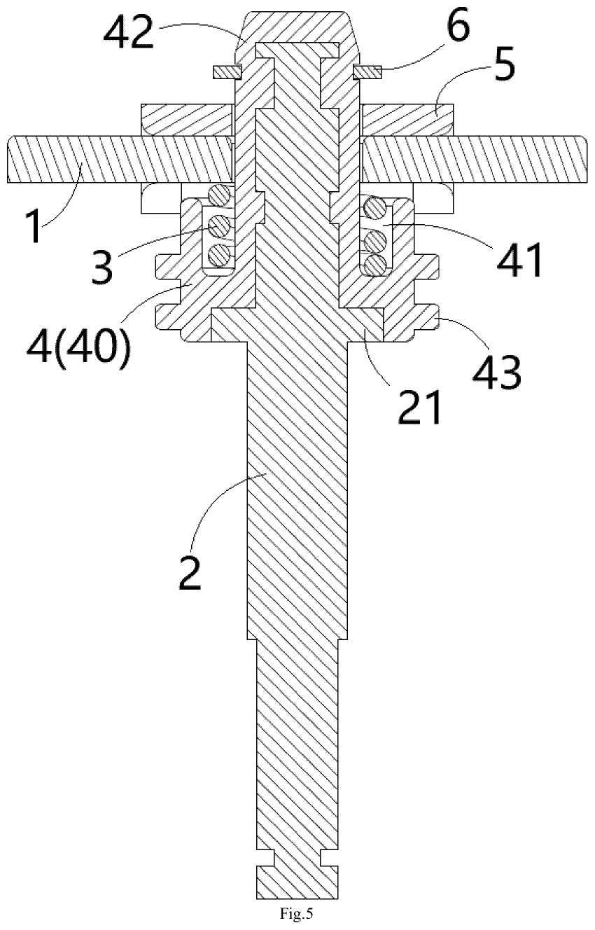

As shown in FIGS. 4 and 5, in a second exemplary embodiment of the present invention, a contactor movable contact assembly is disclosed. The contactor movable contact assembly includes a movable contact 1, a driving shaft 2, a spring component 3, and an insulator 4. The driving shaft 2 is formed with a shoulder 21. The movable contact 1 is axial movably installed on the driving shaft 2 and is located above the shoulder 21. The spring component 3 is axially compressed between the shoulder 21 of driving shaft 2 and the movable contact 1. The insulator 4 is fixed on the driving shaft 2 to electrically isolate the driving shaft 2 from the movable contact 1.

The driving shaft 2 is used to drive the movable contact 1 from an opened position electrically separated from the static contact 9 to a closed position electrically in contact with the static contact 9. When the movable contact 1 is moved to the closed position, the spring component 3 applies a predetermined contact pressure on the movable contact 1 to ensure reliable electrical contact between the movable contact 1 and the static contact 9. The part above the shoulder 21 of the driving shaft 2 is completely wrapped in the insulator 4 to increase the creepage distance between the driving shaft 2 and the movable contact 1.

As shown in FIGS. 4 and 5, in the illustrated embodiment, an annular groove 41 is formed on a base 40 of the insulator 4. The spring component 3 is accommodated in the annular groove 41 of the insulator 4. The upper and lower ends of spring component 3 are respectively pressed against the bottom surface of the movable contact 1 and the inner bottom surface of the annular groove 41 of the insulator 4.

As shown in FIGS. 4 and 5, the contactor movable contact assembly further includes an insulation frame 5. The insulation frame 5 is fixed to the movable contact 1 for driving an auxiliary contact. A through hole is formed in the insulation frame 5 and the movable contact 1 to allow the insulator 4 to pass through.

As shown in FIGS. 4 and 5, in the illustrated embodiment, a limiting ring 6 is installed on the upper end of the insulator 4. As shown in FIG. 4, when the movable contact 1 is in the opened position, the limiting ring 6 is pressed against the top surface of the insulation frame 5 to limit the movable contact 1 at a predetermined position relative to the driving shaft 2. As shown in FIG. 5, when the movable contact 1 is in the closed position, the movable contact 1 is moved axially by a predetermined distance relative to the limiting ring 6, so that the limiting ring 6 is separated from the insulation frame 5 by the predetermined distance.

As shown in FIGS. 4 and 5, in the illustrated embodiment, a top surface and an outer peripheral surface of the shoulder 21 of the driving shaft 2 are completely wrapped in the base 40 of the insulator 4 to further increase the creepage distance between the movable contact 1 and the driving shaft 2. A radial protruding annular flange 43 is formed on the outer peripheral surface of the base 40 of the insulator 4 to further increase the creepage distance between the movable contact 1 and the driving shaft 2. As shown in FIGS. 4 and 5, in the illustrated embodiments, multiple annular flanges 43 are formed on the outer peripheral surface of the base 40 of the insulator 4, and the multiple annular flanges 43 are axially spaced from each other.

In the illustrated embodiment, the insulator 4 is molded onto the driving shaft 2 through embedded injection molding process, so that the insulator 4 and the driving shaft 2 are formed into an integral piece.

In another exemplary embodiment, a contactor is also disclosed. The contactor includes: a housing, a static contact, a coil, and the aforementioned contactor movable contact assembly. The static contact is fixed to the housing. The coil is installed in the housing. The contactor movable contact assembly is movably arranged in the housing. When the coil is energized, the driving shaft 2 drives the movable contact 1 from the open position to the closed position under the electromagnetic force generated by the coil.

In another exemplary embodiment, a contactor without an auxiliary contact is also disclosed. The contactor includes: a housing; a seat provided on the housing; a magnetic circuit assembly installed in the housing; a coil assembly installed in the magnetic circuit assembly; a static contact is fixed to the seat; and the above contactor movable contact assembly movably arranged in the housing. When the coil assembly is energized, the driving shaft 2 drives the movable contact 1 from the opened position to the closed position under the electromagnetic force generated by the coil assembly and the magnetic circuit assembly.

In another exemplary embodiment of the present invention, a contactor with an auxiliary contact is also disclosed. The contactor includes: a housing; a seat provided on the housing; a magnetic circuit assembly installed in the housing; a coil assembly installed in the magnetic circuit assembly; a static contact is fixed to the seat; an auxiliary contact is fixed to the base; and the above contactor movable contact assembly movably arranged in the housing. When the coil assembly is energized, the driving shaft 2 drives the movable contact 1 from the opened position to the closed position under the electromagnetic force generated by the coil assembly and the magnetic circuit assembly, while driving the auxiliary contact to change its contact state. For example, changing the auxiliary contact from an opened state to a closed state or from a closed state to an opened state.

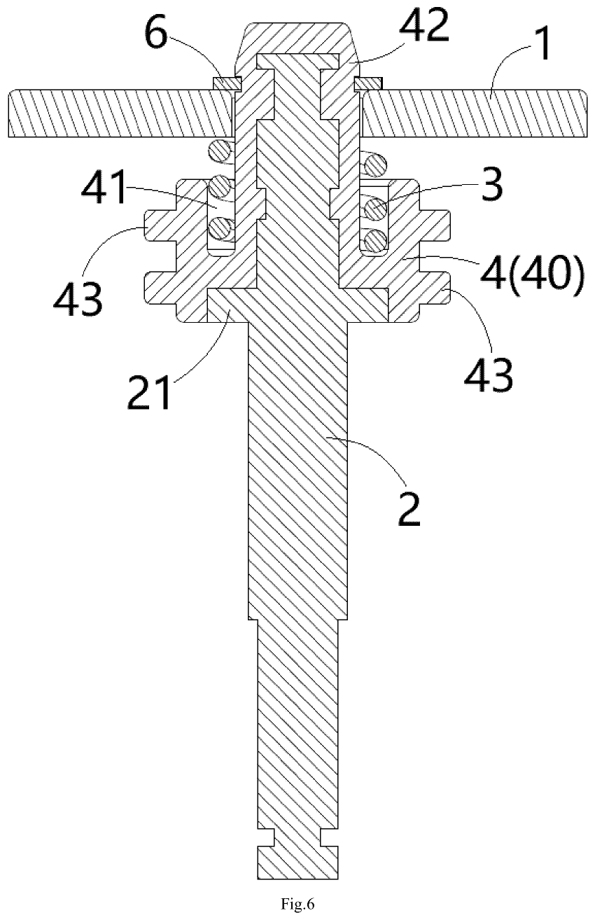

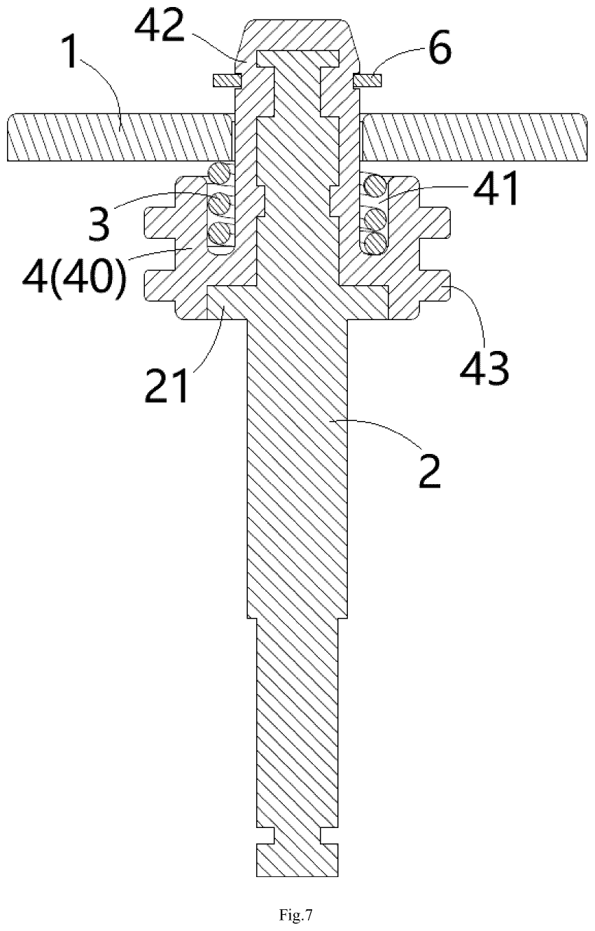

As shown in FIGS. 6 and 7, in a third exemplary embodiment of the present invention, a contactor movable contact assembly is disclosed. The contactor movable contact assembly includes: a movable contact 1, a driving shaft 2, a spring component 3, and an insulator 4. The driving shaft 2 is formed with a shoulder 21. The movable contact 1 is axial movably installed on the driving shaft 2 and is located above the shoulder 21. The spring component 3 is axially compressed between the shoulder 21 of the driving shaft 2 and the movable contact 1. The insulator 4 is fixed on the driving shaft 2 to electrically isolate the driving shaft 2 from the movable contact 1.

The driving shaft 2 is used to drive the movable contact 1 from an opened position electrically separated from the static contact 9 to a closed position electrically in contact with the static contact 9. When the movable contact 1 is moved to the closed position, the spring component 3 applies a predetermined contact pressure on the movable contact 1 to ensure reliable electrical contact between the movable contact 1 and the static contact 9. The part above the shoulder 21 of the driving shaft 2 is completely wrapped in the insulator 4 to increase the creepage distance between the driving shaft 2 and the movable contact 1.

As shown in FIGS. 6 and 7, in the illustrated embodiment, an annular groove 41 is formed on the base 40 of the insulator 4. The spring component 3 is accommodated in the annular groove 41 of the insulator 4. The upper and lower ends of spring component 3 are respectively pressed against the bottom surface of the movable contact 1 and the inner bottom surface of the annular groove 41 of the insulator 4.

As shown in FIGS. 6 and 7, in the illustrated embodiment, a limiting ring 6 is installed on the upper end of the insulator 4. As shown in FIG. 6, when the movable contact 1 is in the opened position, the limiting ring 6 is pressed against the top surface of the movable contact 1 to limit it at a predetermined position relative to the driving shaft 2. As shown in FIG. 7, when the movable contact 1 is in the closed position, the movable contact 1 is moved axially by a predetermined distance relative to the limiting ring 6, so that the limiting ring 6 is separated from the movable contact 1 by the predetermined distance.

As shown in FIGS. 6 and 7, in the illustrated embodiments, a top surface and an outer peripheral surface of the shoulder 21 of the driving shaft 2 are completely wrapped in the base 40 of the insulator 4 to further increase the creepage distance between the movable contact 1 and the driving shaft 2.

As shown in FIGS. 6 and 7, in the illustrated embodiments, a radial protruding annular flange 43 is formed on the outer peripheral surface of the base 40 of the insulator 4 to further increase the creepage distance between the movable contact 1 and the driving shaft 2. In the embodiment, multiple annular flanges 43 are formed on the outer peripheral surface of the base 40 of the insulator 4, and the multiple annular flanges 43 are axially spaced from each other.

In an embodiment, the insulator 4 is molded onto the driving shaft 2 through an embedded injection molding process, so that the insulator 4 and the driving shaft 2 are formed into an integral piece.

In another embodiment, a contactor is also disclosed. The contactor includes a housing, a static contact, a coil, and the contactor movable contact assembly. The static contact is fixed to the housing. The coil is installed in the housing. The contactor movable contact assembly is movably arranged in the housing. When the coil is energized, the driving shaft 2 drives the movable contact 1 from the open position to the closed position under the electromagnetic force generated by the coil.

In another embodiment, a contactor without an auxiliary contact is also disclosed. The contactor includes: a housing; a seat provided on the housing; a magnetic circuit assembly installed in the housing; a coil assembly installed in the magnetic circuit assembly; a static contact is fixed to the seat; and the above contactor movable contact assembly movably arranged in the housing. When the coil assembly is energized, the driving shaft 2 drives the movable contact 1 from the opened position to the closed position under the electromagnetic force generated by the coil assembly and the magnetic circuit assembly.

In another exemplary embodiment, a contactor with an auxiliary contact is also disclosed. The contactor includes: a housing; a seat provided on the housing; a magnetic circuit assembly installed in the housing; a coil assembly installed in the magnetic circuit assembly; a static contact is fixed to the seat; an auxiliary contact is fixed to the base; and the above contactor movable contact assembly movably arranged in the housing. When the coil assembly is energized, the driving shaft 2 drives the movable contact 1 from the opened position to the closed position under the electromagnetic force generated by the coil assembly and the magnetic circuit assembly, while driving the auxiliary contact to change its contact state. For example, changing the auxiliary contact from an opened state to a closed state or from a closed state to an opened state.

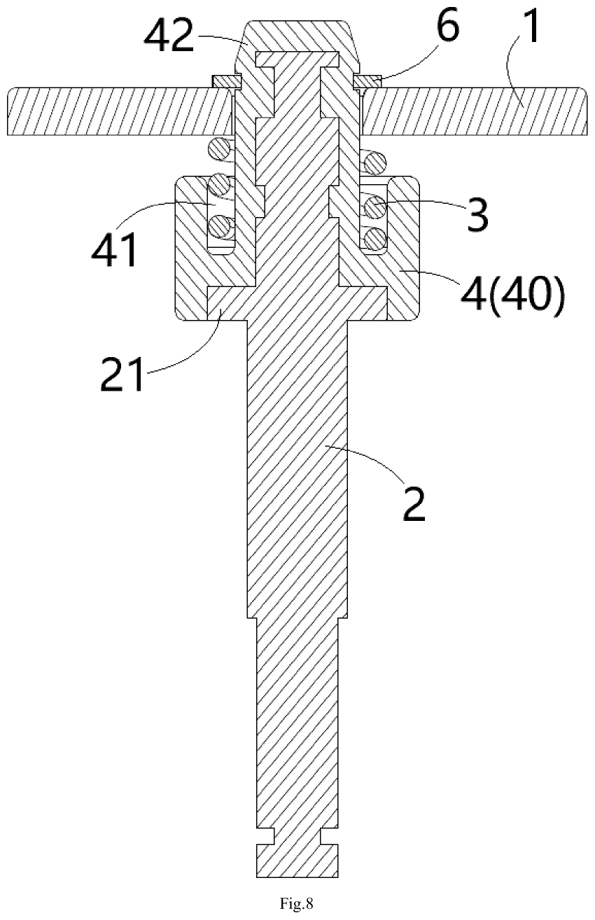

As shown in FIG. 8, in a fourth exemplary embodiment of the present invention, a contactor movable contact assembly is disclosed. The contactor movable contact assembly includes: a movable contact 1, a driving shaft 2, a spring component 3, and an insulator 4. The driving shaft 2 is formed with a shoulder 21. The movable contact 1 is axial movably installed on the driving shaft 2 and is located above the shoulder 21. The spring component 3 is axially compressed between the shoulder 21 of the driving shaft 2 and the movable contact 1. The insulator 4 is fixed on the driving shaft 2 to electrically isolate the driving shaft 2 from the movable contact 1.

The driving shaft 2 is used to drive the movable contact 1 from an opened position electrically separated from the static contact 9 to a closed position electrically in contact with the static contact 9. When the movable contact 1 is moved to the closed position, the spring component 3 applies a predetermined contact pressure on the movable contact 1 to ensure reliable electrical contact between the movable contact 1 and the static contact 9. The part above the shoulder 21 of the driving shaft 2 is completely wrapped in the insulator 4 to increase the creepage distance between the driving shaft 2 and the movable contact 1.

As shown in FIG. 8, in the illustrated embodiment, an annular groove 41 is formed on the base 40 of the insulator 4. The spring component 3 is accommodated in the annular groove 41 of the insulator 4. The upper and lower ends of spring component 3 are respectively pressed against the bottom surface of the movable contact 1 and the inner bottom surface of the annular groove 41 of the insulator 4.

As shown in FIG. 8, in the illustrated embodiment, a limiting ring 6 is installed on the upper end of the insulator 4. As shown in FIG. 8, when the movable contact 1 is in the opened position, the limiting ring 6 is pressed against the top surface of the movable contact 1 to limit it at a predetermined position relative to the driving shaft 2. When the movable contact 1 is in the closed position, the movable contact 1 is moved axially a predetermined distance relative to the limiting ring 6, so that the limiting ring 6 is separated from the movable contact 1 by a predetermined distance.

As shown in FIG. 8, in the illustrated embodiment, a top surface and an outer peripheral surface of the shoulder 21 of the driving shaft 2 are completely wrapped in the base 40 of the insulator 4 to further increase the creepage distance between the movable contact 1 and the driving shaft 2.

In an embodiment, the insulator 4 is formed on the driving shaft 2 through embedded injection molding process, so that the insulator 4 and the driving shaft 2 become an integral piece.

In another embodiment, a contactor is also disclosed. The contactor includes: a housing, a static contact, a coil, and the contactor movable contact assembly. The static contact is fixed to the housing. The coil is installed in the housing. The contactor movable contact assembly is movably arranged in the housing. When the coil is energized, the driving shaft 2 drives the movable contact 1 from the open position to the closed position under the electromagnetic force generated by the coil.

In another embodiment, a contactor without an auxiliary contact is also disclosed. The contactor includes: a housing; a seat provided on the housing; a magnetic circuit assembly installed in the housing; a coil assembly installed in the magnetic circuit assembly; a static contact is fixed to the seat; and the above contactor movable contact assembly movably arranged in the housing. When the coil assembly is energized, the driving shaft 2 drives the movable contact 1 from the opened position to the closed position under the electromagnetic force generated by the coil assembly and the magnetic circuit assembly.

In another embodiment, a contactor with an auxiliary contact is also disclosed. The contactor includes: a housing; a seat provided on the housing; a magnetic circuit assembly installed in the housing; a coil assembly installed in the magnetic circuit assembly; a static contact is fixed to the seat; an auxiliary contact is fixed to the base; and the above contactor movable contact assembly movably arranged in the housing. When the coil assembly is energized, the driving shaft 2 drives the movable contact 1 from the opened position to the closed position under the electromagnetic force generated by the coil assembly and the magnetic circuit assembly, while driving the auxiliary contact to change its contact state. For example, changing the auxiliary contact from an opened state to a closed state or from a closed state to an opened state.

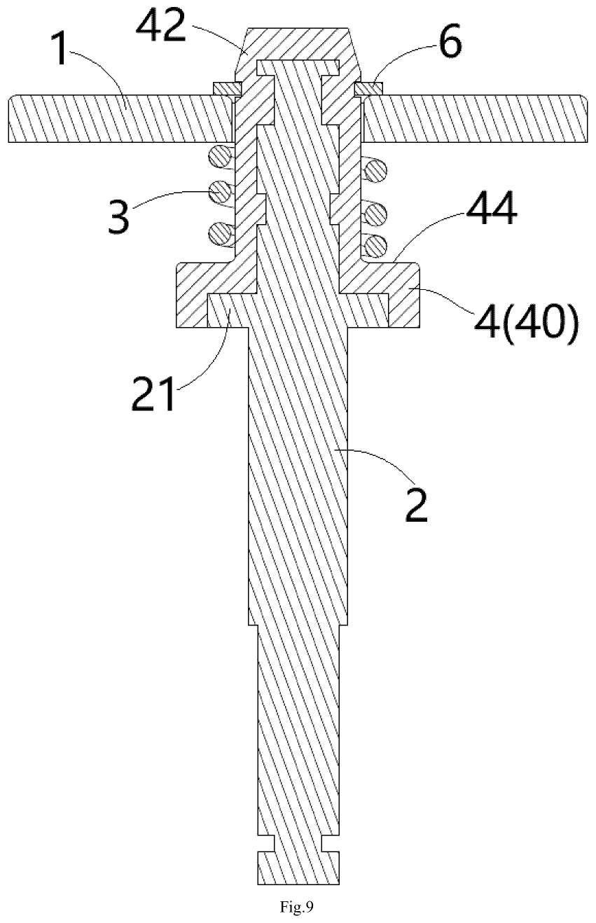

As shown in FIG. 9, in a fifth exemplary embodiment, a contactor movable contact assembly is disclosed. The contactor movable contact assembly includes: a movable contact 1, a driving shaft 2, a spring component 3, and an insulator 4. The driving shaft 2 is formed with a shoulder 21. The movable contact 1 is axially movably installed on the driving shaft 2 and is located above the shoulder 21. The spring component 3 is axially compressed between the shoulder 21 of the driving shaft 2 and the movable contact 1. The insulator 4 is fixed on the driving shaft 2 to electrically isolate the driving shaft 2 from the movable contact 1.

The driving shaft 2 is used to drive the aforementioned movable contact 1 from an opened position electrically separated from the static contact 9 to a closed position electrically in contact with the static contact 9. When the movable contact 1 is moved to the closed position, the spring component 3 applies a predetermined contact pressure on the movable contact 1 to ensure reliable electrical contact between the movable contact 1 and the static contact 9. The part above the shoulder 21 of the driving shaft 2 is completely wrapped in the insulator 4 to increase the creepage distance between the driving shaft 2 and the movable contact 1.

As shown in FIG. 9, in the illustrated embodiment, a supporting step 44 is formed on the base 40 of the insulator 4. The upper and lower ends of spring component 3 are respectively pressed against the bottom surface of movable contact 1 and the support step 44 of insulator 4.

As shown in FIG. 9, in the illustrated embodiment, a limiting ring 6 is installed on the upper end of the insulator 4. As shown in FIG. 9, when the movable contact 1 is in the opened position, the limiting ring 6 is pressed against the top surface of the movable contact 1 to limit it at a predetermined position relative to the driving shaft 2. When the movable contact 1 is in the closed position, the movable contact 1 is moved axially a predetermined distance relative to the limiting ring 6, so that the limiting ring 6 is separated from the movable contact 1 by the predetermined distance.

As shown in FIG. 9, in the illustrated embodiment, a top surface and an outer peripheral surface of the shoulder 21 of the driving shaft 2 are completely wrapped in the base 40 of the insulator 4 to further increase the creepage distance between the movable contact 1 and the driving shaft 2.

In an embodiment, the insulator 4 is formed on the driving shaft 2 through embedded injection molding process, so that the insulator 4 and the driving shaft 2 become an integral piece.

In another embodiment, a contactor is also disclosed. The contactor includes: a housing, a static contact, a coil, and the aforementioned contactor movable contact assembly. The static contact is fixed to the housing. The coil is installed in the housing. The contactor movable contact assembly is movably arranged in the housing. When the coil is energized, the driving shaft 2 drives the movable contact 1 from the open position to the closed position under the electromagnetic force generated by the coil.

In another embodiment, a contactor without an auxiliary contact is also disclosed. The contactor includes: a housing; a seat provided on the housing; a magnetic circuit assembly installed in the housing; a coil assembly installed in the magnetic circuit assembly; a static contact is fixed to the seat; and the above contactor movable contact assembly movably arranged in the housing. When the coil assembly is energized, the driving shaft 2 drives the movable contact 1 from the opened position to the closed position under the electromagnetic force generated by the coil assembly and the magnetic circuit assembly.

In another embodiment, a contactor with an auxiliary contact is also disclosed. The contactor includes: a housing; a seat provided on the housing; a magnetic circuit assembly installed in the housing; a coil assembly installed in the magnetic circuit assembly; a static contact is fixed to the seat; an auxiliary contact is fixed to the base; and the above contactor movable contact assembly movably arranged in the housing. When the coil assembly is energized, the driving shaft 2 drives the movable contact 1 from the opened position to the closed position under the electromagnetic force generated by the coil assembly and the magnetic circuit assembly, while driving the auxiliary contact to change its contact state. For example, changing the auxiliary contact from an opened state to a closed state or from a closed state to an opened state.

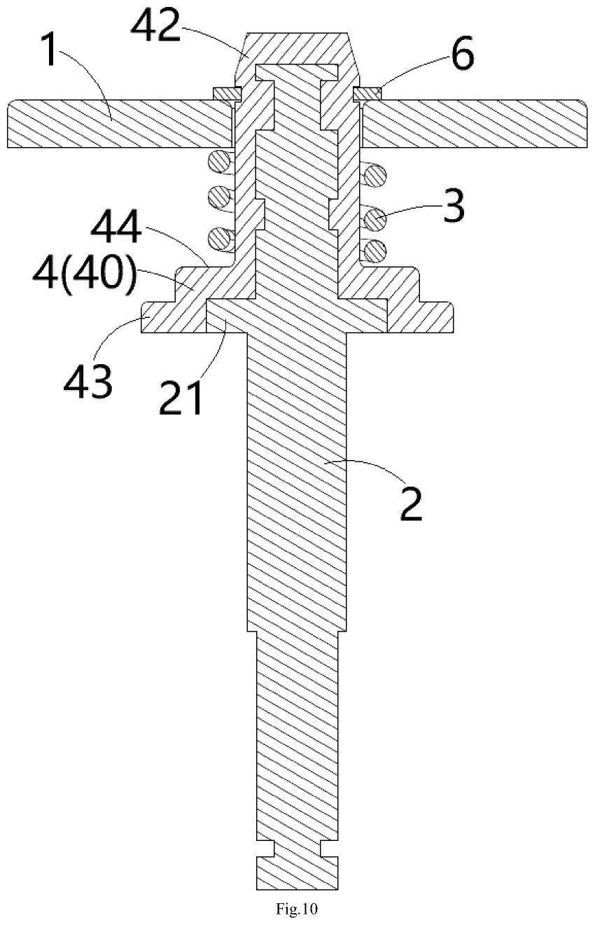

As shown in FIG. 10, in a sixth exemplary embodiment of the present invention, a contactor movable contact assembly is disclosed. The contactor movable contact assembly includes: a movable contact 1, a driving shaft 2, a spring component 3, and an insulator 4. The driving shaft 2 is formed with a shoulder 21. The movable contact 1 is axial movably installed on the driving shaft 2 and is located above the shoulder 21. The spring component 3 is axially compressed between the shoulder 21 of the driving shaft 2 and the movable contact 1. The insulator 4 is fixed on the driving shaft 2 to electrically isolate the driving shaft 2 from the movable contact 1.

The driving shaft 2 is used to drive the movable contact 1 from an opened position electrically separated from the static contact 9 to a closed position electrically in contact with the static contact 9. When the movable contact 1 is moved to the closed position, the spring component 3 applies a predetermined contact pressure on the movable contact 1 to ensure reliable electrical contact between the movable contact 1 and the static contact 9. The part above the shoulder 21 of the driving shaft 2 is completely wrapped in the insulator 4 to increase the creepage distance between the driving shaft 2 and the movable contact 1.

As shown in FIG. 10, in the illustrated embodiment, a supporting step 44 is formed on the base 40 of the insulator 4. The upper and lower ends of spring component 3 are respectively pressed against the bottom surface of movable contact 1 and the support step 44 of the insulator 4.

As shown in FIG. 10, in the illustrated embodiment, a limiting ring 6 is installed on the upper end of the insulator 4. As shown in FIG. 10, when the movable contact 1 is in the opened position, the limiting ring 6 is pressed against the top surface of the movable contact 1 to limit it at a predetermined position relative to the driving shaft 2. When the movable contact 1 is in the closed position, the movable contact 1 is moved axially a predetermined distance relative to the limiting ring 6, so that the limiting ring 6 is separated from the movable contact 1 by the predetermined distance.

As shown in FIG. 10, in the illustrated embodiment, a top surface and an outer peripheral surface of the shoulder 21 of the driving shaft 2 are completely wrapped in the base 40 of the insulator 4 to further increase the creepage distance between the movable contact 1 and the driving shaft 2. A radial protruding annular flange 43 is formed on the outer peripheral surface of the base 40 of the insulator 4 to further increase the creepage distance between the movable contact 1 and the driving shaft 2.

In an embodiment, the insulator 4 is formed on the driving shaft 2 through embedded injection molding process, so that the insulator 4 and the driving shaft 2 become an integral piece.

In another embodiment, a contactor is also disclosed. The contactor includes: a housing, a static contact, a coil, and the aforementioned contactor movable contact assembly. The static contact is fixed to the housing. The coil is installed in the housing. The contactor movable contact assembly is movably arranged in the housing. When the coil is energized, the driving shaft 2 drives the movable contact 1 from the open position to the closed position under the electromagnetic force generated by the coil.

In another embodiment, a contactor without an auxiliary contact is also disclosed. The contactor includes: a housing; a seat provided on the housing; a magnetic circuit assembly installed in the housing; a coil assembly installed in the magnetic circuit assembly; a static contact is fixed to the seat; and the above contactor movable contact assembly movably arranged in the housing. When the coil assembly is energized, the driving shaft 2 drives the movable contact 1 from the opened position to the closed position under the electromagnetic force generated by the coil assembly and the magnetic circuit assembly.

In another embodiment, a contactor with an auxiliary contact is also disclosed. The contactor includes: a housing; a seat provided on the housing; a magnetic circuit assembly installed in the housing; a coil assembly installed in the magnetic circuit assembly; a static contact is fixed to the seat; an auxiliary contact is fixed to the base; and the above contactor movable contact assembly movably arranged in the housing. When the coil assembly is energized, the driving shaft 2 drives the movable contact 1 from the opened position to the closed position under the electromagnetic force generated by the coil assembly and the magnetic circuit assembly, while driving the auxiliary contact to change its contact state. For example, changing the auxiliary contact from an opened state to a closed state or from a closed state to an opened state.

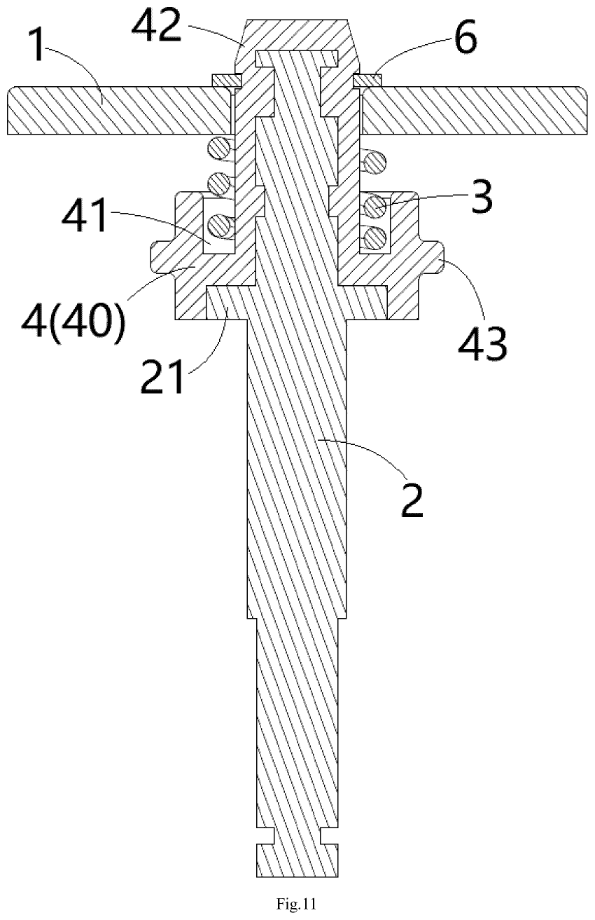

As shown in FIG. 11, in a seventh exemplary embodiment of the present invention, a contactor movable contact assembly is disclosed. The contactor movable contact assembly includes: a movable contact 1, a driving shaft 2, a spring component 3, and an insulator 4. The driving shaft 2 is formed with a shoulder 21. The movable contact 1 is axial movably installed on the driving shaft 2 and is located above the shoulder 21. The spring component 3 is axially compressed between the shoulder 21 of the driving shaft 2 and the movable contact 1. The insulator 4 is fixed on the driving shaft 2 to electrically isolate the driving shaft 2 from the movable contact 1.

The driving shaft 2 is used to drive the movable contact 1 from an opened position electrically separated from the static contact 9 to a closed position electrically in contact with the static contact 9. When the movable contact 1 is moved to the closed position, the spring component 3 applies a predetermined contact pressure on the movable contact 1 to ensure reliable electrical contact between the movable contact 1 and the static contact 9. The part above the shoulder 21 of the driving shaft 2 is completely wrapped in the insulator 4 to increase the creepage distance between the driving shaft 2 and the movable contact 1.

As shown in FIG. 11, in the illustrated embodiment, an annular groove 41 is formed on the base 40 of the insulator 4. The spring component 3 is accommodated in the annular groove 41 of the insulator 4. The upper and lower ends of spring component 3 are respectively pressed against the bottom surface of the movable contact 1 and the inner bottom surface of the annular groove 41 of the insulator 4.

As shown in FIG. 11, in the illustrated embodiment, a limiting ring 6 is installed on the upper end of the insulator 4. As shown in FIG. 11, when the movable contact 1 is in the opened position, the limiting ring 6 is pressed against the top surface of the movable contact 1 to limit it at a predetermined position relative to the driving shaft 2. When the movable contact 1 is in the closed position, the movable contact 1 is moved axially a predetermined distance relative to the limiting ring 6, so that the limiting ring 6 is separated from the movable contact 1 by the predetermined distance.

As shown in FIG. 11, in the illustrated embodiment, a top surface and an outer peripheral surface of the shoulder 21 of the driving shaft 2 are completely wrapped in the base 40 of the insulator 4 to further increase the creepage distance between the movable contact 1 and the driving shaft 2. A radial protruding annular flange 43 is formed on the outer peripheral surface of the base 40 of the insulator 4 to further increase the creepage distance between the movable contact 1 and the driving shaft 2.

In an embodiment, the insulator 4 is molded onto the driving shaft 2 through an embedded injection molding process, so that the insulator 4 and the driving shaft 2 are formed into an integral piece.

In another embodiment, a contactor is also disclosed. The contactor includes: a housing, a static contact, a coil, and the aforementioned contactor movable contact assembly. The static contact is fixed to the housing. The coil is installed in the housing. The contactor movable contact assembly is movably arranged in the housing. When the coil is energized, the driving shaft 2 drives the movable contact 1 from the open position to the closed position under the electromagnetic force generated by the coil.

In another embodiment, a contactor without an auxiliary contact is also disclosed. The contactor includes: a housing; a seat provided on the housing; a magnetic circuit assembly installed in the housing; a coil assembly installed in the magnetic circuit assembly; a static contact is fixed to the seat; and the above contactor movable contact assembly movably arranged in the housing. When the coil assembly is energized, the driving shaft 2 drives the movable contact 1 from the opened position to the closed position under the electromagnetic force generated by the coil assembly and the magnetic circuit assembly.

In another embodiment, a contactor with an auxiliary contact is also disclosed. The contactor includes: a housing; a seat provided on the housing; a magnetic circuit assembly installed in the housing; a coil assembly installed in the magnetic circuit assembly; a static contact is fixed to the seat; an auxiliary contact is fixed to the base; and the above contactor movable contact assembly movably arranged in the housing. When the coil assembly is energized, the driving shaft 2 drives the movable contact 1 from the opened position to the closed position under the electromagnetic force generated by the coil assembly and the magnetic circuit assembly, while driving the auxiliary contact to change its contact state. For example, changing the auxiliary contact from an opened state to a closed state or from a closed state to an opened state.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A contactor movable contact assembly, comprising:
a driving shaft having a shoulder;
a movable contact movably installed axially on the driving shaft and positioned above the shoulder;
a spring component axially compressed between the shoulder of the driving shaft and the movable contact; and
an insulator fixed on the driving shaft and electrically isolating the driving shaft from the movable contact, the driving shaft drives the movable contact from an opened position electrically separated from a static contact to a closed position electrically in contact with the static contact, the spring component applies a predetermined contact pressure on the movable contact to ensure reliable electrical contact between the movable contact and the static contact, a portion of the driving shaft between the shoulder and an upper end of the driving shaft is completely wrapped in the insulator to increase a creepage distance between the driving shaft and the movable contact.

2. The contactor movable contact assembly of claim 1, wherein the upper end of the driving shaft is also completely wrapped in the insulator and a part of the driving shaft above the shoulder is completely wrapped in the insulator.

3. The contactor movable contact assembly of claim 1, further comprising an insulation frame fixed to the movable contact, the insulation frame drives the auxiliary contact and electrically isolates the spring component from the movable contact, a through hole is formed in the insulation frame and the movable contact to allow the insulator to pass through.

4. The contactor movable contact assembly of claim 3, wherein the insulator is cylindrical and extends continuously from a top surface of the shoulder of the driving shaft to a vicinity of the upper end of the driving shaft.

5. The contactor movable contact assembly of claim 4, wherein the spring component is mounted on the insulator, an upper end of the insulator is pressed against a bottom surface of the insulation frame and a lower end of the insulator is pressed against the top surface of the shoulder of the driving shaft.

6. The contactor movable contact assembly of claim 5, wherein the upper end of the driving shaft is exposed from the insulator, and a limiting ring is installed on the upper end of the driving shaft.

7. The contactor movable contact assembly of claim 6, wherein the limiting ring is pressed against a top surface of the insulation frame to limit the movable contact at a predetermined position relative to the driving shaft when the movable contact is in the opened position, and the movable contact is moved axially a predetermined distance relative to the limiting ring so that the limiting ring is separated from the insulation frame by the predetermined distance when the movable contact is in the closed position.

8. The contactor movable contact assembly of claim 2, wherein the insulator has an annular groove in a base, the spring component is accommodated in the annular groove of the insulator, an upper end of the spring component is pressed against a bottom surface of the movable contact and a lower end of the spring component is pressed against an inner bottom surface of the annular groove.

9. The contactor movable contact assembly of claim 8, further comprising an insulation frame fixed to the movable contact and driving an auxiliary contact, a through hole is formed in the insulation frame and the movable contact to allow the insulator to pass through.

10. The contactor movable contact assembly of claim 9, wherein a limiting ring is installed on an upper end of the insulator, the limiting ring is pressed against a top surface of the insulation frame to limit the movable contact at a predetermined position relative to the driving shaft when the movable contact is in the opened position, and the movable contact is moved axially a predetermined distance relative to the limiting ring so that the limiting ring is separated from the insulation frame by the predetermined distance when the movable contact is in the closed position.

11. The contactor movable contact assembly of claim 8, wherein a limiting ring is installed on an upper end of the insulator, the limiting ring is pressed against a top surface of the movable contact to limit the movable contact at a predetermined position relative to the driving shaft when the movable contact is in the opened position, and the movable contact is moved axially a predetermined distance relative to the limiting ring so that the limiting ring is separated from the movable contact by the predetermined distance when the movable contact is in the closed position.

12. The contactor movable contact assembly of claim 2, wherein a support step is formed on a base of the insulator, an upper end of the spring component is supported against a bottom surface of the movable contact and a lower end of the spring component is supported against the support step.

13. The contactor movable contact of claim 12, wherein a limiting ring is installed on the upper end of the insulator, the limiting ring is pressed against a top surface of the movable contact to limit the movable contact at a predetermined position relative to the driving shaft when the movable contact is in the opened position, and the movable contact is moved axially a predetermined distance relative to the limiting ring so that the limiting ring is separated from the movable contact by the predetermined distance when the movable contact is in the closed position.

14. The contactor movable contact assembly of claim 2, wherein a top surface and an outer peripheral surface of the shoulder of the driving shaft are completely wrapped in a base of the insulator and further increase the creepage distance between the movable contact and the driving shaft.

15. The contactor movable contact assembly of claim 2, wherein an annular flange is formed on an outer peripheral surface of a base of the insulator and further increases the creepage distance between the movable contact and the driving shaft.

16. The contactor movable contact assembly of claim 2, wherein a top surface and an outer peripheral surface of the shoulder of the driving shaft are completely wrapped in a base of the insulator, and an annular flange is formed on an outer peripheral surface of the base of the insulator to further increase the creepage distance between the movable contact and the driving shaft.

17. The contactor movable contact assembly of claim 15, wherein a plurality of annular flanges are formed on the outer peripheral surface of the base of the insulator, the annular flanges are axially spaced from each other.

18. The contactor movable contact assembly of claim 1, wherein the insulator is formed on the driving shaft through an embedded injection molding process, the insulator and the driving shaft are formed into an integral piece.

19. A contactor, comprising:
a housing;
a seat disposed on the housing;
a magnetic circuit assembly installed in the housing;
a coil assembly installed in the magnetic circuit assembly;
a static contact fixed to the seat; and
a contactor movable contact assembly movably arranged in the housing, the contactor movable contact assembly includes:
a driving shaft having a shoulder;
a movable contact movably installed axially on the driving shaft and positioned above the shoulder;
a spring component axially compressed between the shoulder of the driving shaft and the movable contact; and
an insulator fixed on the driving shaft and electrically isolating the driving shaft from the movable contact, the driving shaft drives the movable contact from an opened position electrically separated from a static contact to a closed position electrically in contact with the static contact, the spring component applies a predetermined contact pressure on the movable contact to ensure reliable electrical contact between the movable contact and the static contact, a portion of the driving shaft between the shoulder and an upper end of the driving shaft is completely wrapped in the insulator to increase a creepage distance between the driving shaft and the movable contact, and when the coil assembly is energized, the driving shaft drives the movable contact from the opened position to the closed position under an electromagnetic force generated by the coil assembly and the magnetic circuit assembly.

20. A contactor, comprising:
a housing;
a seat disposed on the housing;
a magnetic circuit assembly installed in the housing;
a coil assembly installed in the magnetic circuit assembly;
a static contact fixed to the seat;
an auxiliary contact fixed to the seat; and
a contactor movable contact assembly movably arranged in the housing, the contactor movable contact assembly includes:
a driving shaft having a shoulder;
a movable contact movably installed axially on the driving shaft and positioned above the shoulder;
a spring component axially compressed between the shoulder of the driving shaft and the movable contact; and
an insulator fixed on the driving shaft and electrically isolating the driving shaft from the movable contact, the driving shaft drives the movable contact from an opened position electrically separated from a static contact to a closed position electrically in contact with the static contact, the spring component applies a predetermined contact pressure on the movable contact to ensure reliable electrical contact between the movable contact and the static contact, a portion of the driving shaft between the shoulder and an upper end of the driving shaft is completely wrapped in the insulator to increase a creepage distance between the driving shaft and the movable contact, and when the coil assembly is energized, the driving shaft drives the movable contact from the opened position to the closed position under an electromagnetic force generated by the coil assembly and the magnetic circuit assembly, while driving the auxiliary contact to change a contact state.
